(19) United States
(12) Patent Application Publication
(10) Pub. No.: US 2009/0199163 A1
(43) Pub. Date: Aug. 6, 2009

(54) DEBUGGER ASSISTANCE FOR LOCATING VALUES AT RUNTIME

(75) Inventors: Danny Soroker, Larchmont, NY (US); Robert M. Fuhrer, Peekskill, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/023,253

(22) Filed: Jan. 31, 2008

(51) Int. Cl. G06F 9/44

(52) U.S. Cl. 717/128

(57) ABSTRACT

A software module for searching within a software debugging environment is provided. The software module comprises a search component and an interface component. The search component is configured to be implemented within a debugging tool configured to access a set of execution state data for a program being monitored by the debugging tool when execution of the program is stopped. The search component is configured to search the set of execution state data to locate instances of a particular value. The interface component is configured to allow a user to specify the particular value in a search query, submit the search query to the search component, and present a description of each instance of the particular value located by the search component to the user.

### FIELD OF THE INVENTION

Exemplary embodiments of the present invention relate to software debugging environments, and more particularly, to searching execution state data within a software debugging environment.

### DESCRIPTION OF BACKGROUND

Software development tools are software applications that enable a software developer to write software applications. Certain tools, for instance, can be employed to aid in understanding program behavior, an important aspect of software development. Such an understanding can ensure that a program being developed will operate as expected and correctly interact with external libraries and frameworks. Examples of tools that can be employed to gain an understanding of program behavior include tracing tools for tracing execution of a program and debugger tools that enable inspection and testing of the behavior of running programs.

Many software developers find it convenient to utilize a single umbrella application, known as an integrated development environment (IDE) such as Eclipse or Microsoft Visual Studio, that includes several software development tools. A typical IDE provides an environment incorporating tools for source code editing, compiling, linking, testing, debugging, and profiling. By presenting a single program in which all or much of the development can be done, an IDE environment can enhance the value of each individual tool (for example, a debugger) by having it integrate seamlessly with the other development tools included in the IDE. The advantage of using an IDE is that the software developer need not be concerned about the tool interfaces when moving from one phase of code development to the other.

As mentioned, the functions that are incorporated into the tools of an IDE may include debugging and tracing, profiling, and logging. Debugging is used to locate and identify errors in a computer program under development. Some debuggers provide the ability to modify the state of the program while it is running, rather than to merely observe it. Tracing is used to print the values of the variables and identify the conditions at a particular statement.

“Step” functions and breakpoint operations are two primary operations that are supported by conventional debuggers to assist a software developer in acquiring knowledge about a program during its execution. A step function permits statements in a computer program to be executed one at a time and displays the results of each instruction upon completion. While the step operation provides a programmer with a large amount of information about a program during its execution, the task of stepping through hundreds or thousands of program instructions may be tedious and time consuming. A breakpoint operation permits a computer programmer to intentionally halt the execution of a computer program at a precise instruction.

Used together, step operations and breakpoints can simplify the debugging process. A computer program executes normally by a debugger until a breakpoint is reached, at which point the program stops execution and the debugger displays various aspects of the program state, such as the call stack and the contents of memory, to the programmer for analysis. The programmer can then step through the code line-by-line using the step operation. The programmer is thus able to isolate and analyze a particular set of instructions without having to step through irrelevant portions of a computer program.

A limitation of existing debuggers for inspecting memory state is that program variables are presented by their name, which may require that the programmer have detailed symbolic information regarding all of the relevant data types, variables, and so on to be able discover the contents and structure of the data within a program invocation. This can become problematic in situations where data structures are complex and deeply nested, particularly when the data structures in question belong to a predefined library or framework that was authored by someone other than the programmer performing the debugging. In these situations, when a programmer encounters a debugging problem in executing a software program, part of the debugging task can involve time-intensive “hunting” for the desired variable or field, as there can be many variables in the current context of a running program. In particular, finding a particular value (such as a given string or number) may be hard to do. The typical solution is to manually traverse the set of variables and repeatedly access the sub-structures of data structures to reveal nested data. This can be time consuming and frustrating, and is impractical for large data structures containing thousands or millions of nodes.

Related work in the literature includes systems that enhance the debugger with interactive commands to search and display complex data structures. For example, the “Duel” system (USENIX 1993 paper, available at http://citeseer.ist.psu.edu/golan93duel.html) extends the GNU debugger, GDB, with support for such scripting language commands. Among the features of the Duel scripting language is the ability to find values within arrays and data structures specified by the developer. A significant limitation of this approach is that the developer needs knowledge of the data structures in order to specify where to search for a given value, which reduces the value of the debugger as a program understanding tool. Another disadvantage is that each query so formed is bound to a specific arrangement of data structures. That is, it will find matching values within a particular field of a particular data type, but will not find matches within other fields of other data types. Yet another disadvantage is the need to master an additional language, that is, the scripting language.

### SUMMARY OF THE INVENTION

The shortcomings of the prior art can be overcome and additional advantages can be provided through exemplary embodiments of the present invention that are related to a software module for searching within a software debugging environment. The software module comprises a search component and an interface component. The search component is configured to be implemented within a debugging tool configured to access a set of execution state data for a program being monitored by the debugging tool when execution of the program is stopped. The search component is configured to search the set of execution state data to locate instances of a particular value. The interface component is configured to allow a user to specify the particular value in a search query, submit the search query to the search component, and present a description of each instance of the particular value located by the search component to the user.

The shortcomings of the prior art can also be overcome and additional advantages can also be provided through exemplary embodiments of the present invention that are related to methods, computer program products, and data processing systems corresponding to the above-summarized module are also described herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of exemplary embodiments of the summarized invention, technically we have achieved a solution that can be implemented within a software debugging environment to improve tool support for program understanding by providing a search mechanism enabling a programmer to locate instances of data by value, rather than by its symbolic attachment to known variables.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description of exemplary embodiments of the present invention taken in conjunction with the accompanying drawings in which:

FIG. 1 is an illustration of a sample screenshot of the variables viewer window provided in the Eclipse IDE.

FIG. 2 is a flow diagram illustrating an example of a general process for performing a search by value in a software debugging environment using an exemplary embodiment of the present invention.

FIG. 3 is a flow diagram illustrating a sample process of interaction by a developer for performing a search by value in an IDE using an exemplary embodiment of the present invention.

FIG. 4 is an illustration of a search query dialog box in accordance with an exemplary embodiment of the present invention.

FIG. 5 is an illustration of a search results dialog box in accordance with an exemplary embodiment of the present invention.

FIG. 6 is an illustration of a search results viewer window in accordance with an exemplary embodiment of the present invention.

The detailed description explains exemplary embodiments of the present invention, together with advantages and features, by way of example with reference to the drawings. The flow diagrams depicted herein are just examples. There may be many variations to these diagrams or the steps (or operations) described therein without departing from the spirit of the invention. For instance, the steps may be performed in a differing order, or steps may be added, deleted, or modified. All of these variations are considered a part of the claimed invention.

### DETAILED DESCRIPTION OF EXEMPLARY EMBODIMENTS

While the specification concludes with claims defining the features of the invention that are regarded as novel, it is believed that the invention will be better understood from a consideration of the description of exemplary embodiments in conjunction with the drawings. It is of course to be understood that the embodiments described herein are merely exemplary of the invention, which can be embodied in various forms. Therefore, specific structural and functional details disclosed in relation to the exemplary embodiments described herein are not to be interpreted as limiting, but merely as a representative basis for teaching one skilled in the art to variously employ the present invention in virtually any appropriate form. Further, the terms and phrases used herein are not intended to be limiting but rather to provide an understandable description of the invention.

A typical debugging tool executes as a self-contained process for controlling an application program under study by using operating system primitives designed for that purpose. Debuggers are commonly used for examining the execution state or context of running program, which can include, for example, the call stack and the current state of variables, registers, and storage. In particular, a debugger can enable a developer to intentionally stop or pause a running program at a breakpoint and inspect the execution state (logs, memory, files, etc.) in the test environment to determine whether the program functions as expected. In general, a breakpoint can consist of one or more conditions that determine when a program's execution should be interrupted. Breakpoints can be set by a developer so that program execution halts, for example, when a specific line number or instruction is reached, upon entry to a specific function, at a specific time, when a specific module is loaded, upon a specific keystroke, and when a specific location in storage is read from, written to, or modified.

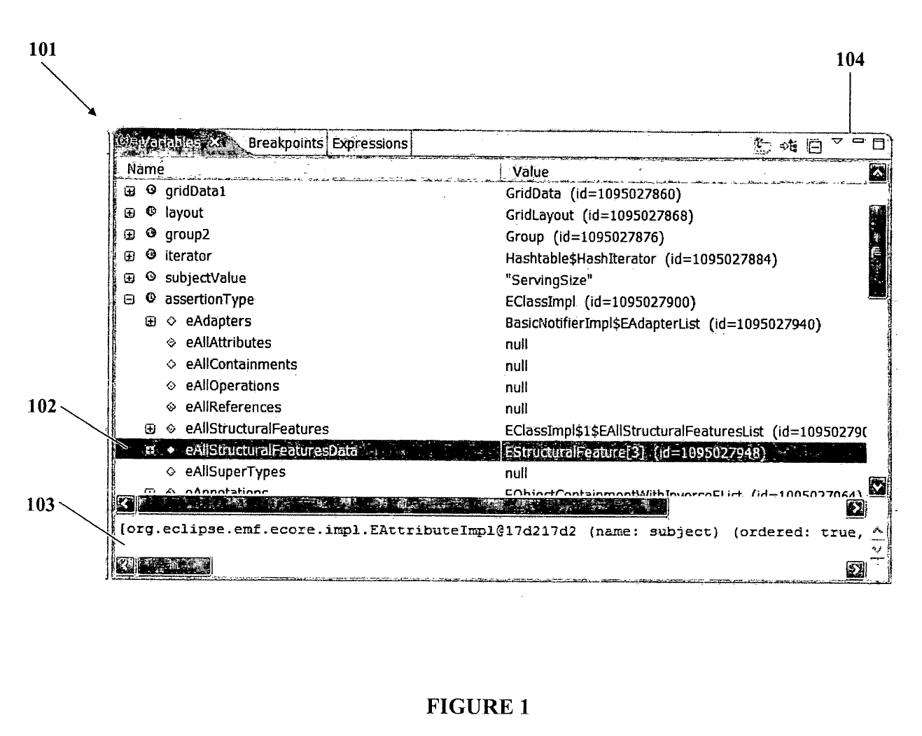

Debugging tools are commonly implemented with a command line interface (CLI), a textual user interface (TUI), or a graphical user interface (GUI). A GUI debugger typically provides a window in which a list of variables and their respective values are displayed in a frame during the operation of the debugger. As an example of such a debugging window, FIG. 1 illustrates a sample screenshot of the variables viewer window 101 provided in Eclipse, which is an open-source software framework written primarily in Java that provides an IDE for Java developers in its default form. Eclipse software provides a common set of services and establishes a framework, infrastructure, and interactive workbench for building application software and related elements. In the exemplary screenshot of FIG. 1, variables viewer window 101 displays the names and values of variables accessible at the program location and stack frame of the current execution state, and may optionally also display heap variables. When a variable is selected by a user (for example, variable ‘eAllStructuralFeaturesData’ 102 in FIG. 1), the display for the variable is highlighted in window 101 and an expanded view of the value of the selected variable is displayed in a details frame 103. Variables viewer window 101 supports various options and operations, which can be invoked through various GUI widgets provided with the window such as buttons and a menu bar 104.

As demonstrated by FIG. 1, many variables can be present in the current context of a running program. Exemplary embodiments of the present invention can be implemented within a software debugging environment to improve tool support for program understanding by providing a search mechanism assisting a programmer in locating instances of data by value, rather than by attachment to known variables. For instance, an exemplary embodiment implemented within variable viewer window 101 of FIG. 1 could provide a “search by value” GUI element that is accessible through menu bar 104. Such an interface could be utilized by a developer, for example, to search for the value “ServingSize” within the current execution state of the program. Thus, by providing such a search-by-value mechanism for a debugging tool, exemplary embodiments can be implemented to enable a programmer to search through the data accessible to a running program for a value of interest more efficiently and more easily find runtime instances of a particular value. Exemplary embodiments can thus be valuable for better understanding how a program operates, as various reverse-engineering tasks can be performed by searching for particular values when execution of the program is paused at a breakpoint, such as identifying the variable or variables in which the program has stored a given value. For example, when using an external framework (or library), exemplary embodiments can help a programmer understand how the framework stores data from an input source into its data structures. As another example, exemplary embodiments can help a programmer hone in on a bug by checking which of the fields nested within a data structure are uninitialized (by searching for occurrences of a default or “null” value).

Exemplary embodiments of the present invention can be implemented as a search module providing an interface within a software debugging environment by providing the following components: (1) A user interface for specifying the value or values for which to search (as well as, in exemplary embodiments, other search parameters); (2) a module configured to perform the search for the specified values within the data accessible to the program at a given moment in the program's execution; and (3) a user interface for displaying the search results. In exemplary embodiments in which the debugging tool is provided within a GUI (for instance, as a GUI interface provided by an IDE; for example, an exemplary embodiment could be implemented by the Standard Widget Toolkit provided by Eclipse), then the above components could be incorporated into the GUI and made accessible using widgets. For example, the user interface for specifying the search could be implemented in a text or dialog box and the search results can be displayed in a viewer window or in a child window. In exemplary embodiments in which the debugging tool is provided within a TUI (for instance, the GNU Debugger (GDB)), the above components could be incorporated using the available text and symbols provided by the interface. In exemplary embodiments in which the debugging tool is provided within a CLI, the above components could be incorporated into the CLI as functionality that be accessed using syntax and semantics that can be entered in the command line shell and configured to present search results in the text interface.

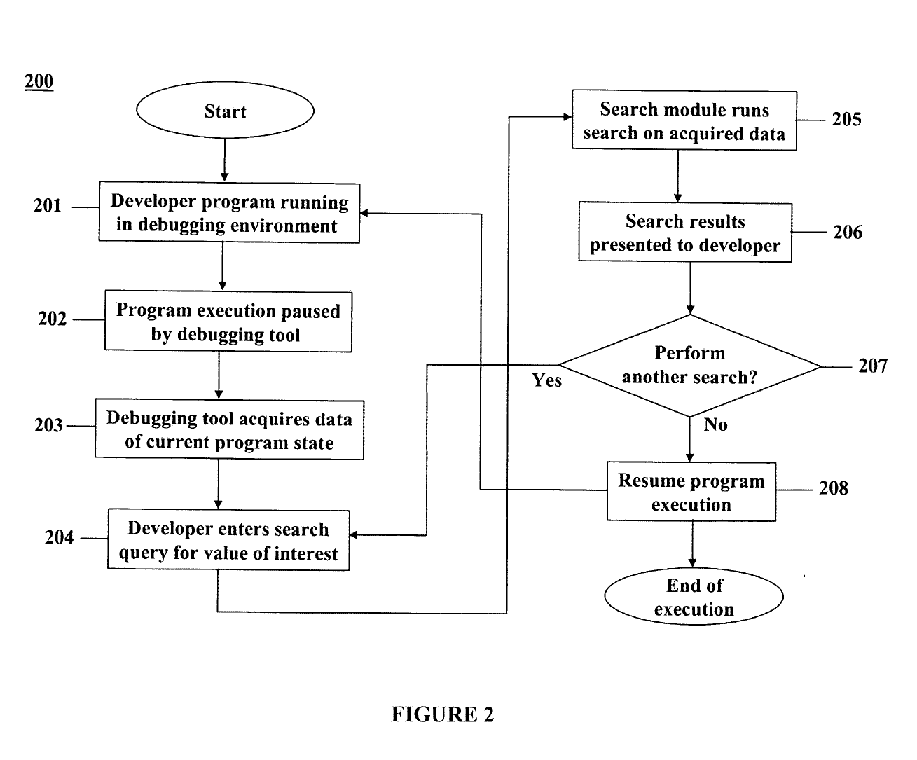

Referring now to FIG. 2, a flow diagram is illustrated showing an example of a general process 200 for performing a search by value in a software debugging environment in which an exemplary embodiment of a search module in accordance with the present invention has been implemented. Exemplary process 200 begins at block 201 with the program being studied by the developer currently running in the debugging environment. At block 202, execution of the running program is stopped or paused within the debugging tool, for example, due to a breakpoint, crash, end of execution, trapping exception, core dump, etc. Once program execution has been stopped, at block 203, the debugging tool can determine the current context data of the program that is accessible and acquire various aspects of that data, such as the call stack and contents of memory, from which to build data structure representations. The debugging tool can do this by, for example, employing any standard methods and application programming interfaces (APIs) or libraries made available by the operating system or an execution platform (such as a “virtual machine”) for determining data accessibility and building data structures representing the accessible data. In exemplary embodiments, the data that is accessible can vary according to the particular debugging in which the search module is implemented.

In the present exemplary process, at block 204, the developer accesses the interface provided by the search module to enter a search query for a particular value of interest and submits the search to the search module. At block 205, the search module runs the search on the accessible data acquired at block 203. In exemplary embodiments, the search module can perform the search by scanning the current program context and recursively examining data structures as needed. In implementing the search module, care can be taken to avoid infinite loops that could occur in the presence of cycles (such as might occur in the case of data structures with both “parent” and “child” pointers). At block 206, the search results are presented to the developer by the interface provided by the search module in some fashion. In exemplary embodiments, the search interface may be implemented so as to provide the developer with the option to, at decision block 207, perform additional searches for values of interest, in which case the process returns to block 204 to accept a new search query from the developer. At block 208, after the developer has completed any desired searching, execution of the program can be resumed, and the process returns to block 201 until the program terminates. It should be noted that while the process illustrated in FIG. 2 describes a non-limiting exemplary embodiment for searching the data of a currently executing program, exemplary embodiments can also be applied to perform other forms of program-data searches, such as, for example, searching through the execution history of a terminated program for particular values of interest or searching the current execution state while performing step operations through lines of program instructions.

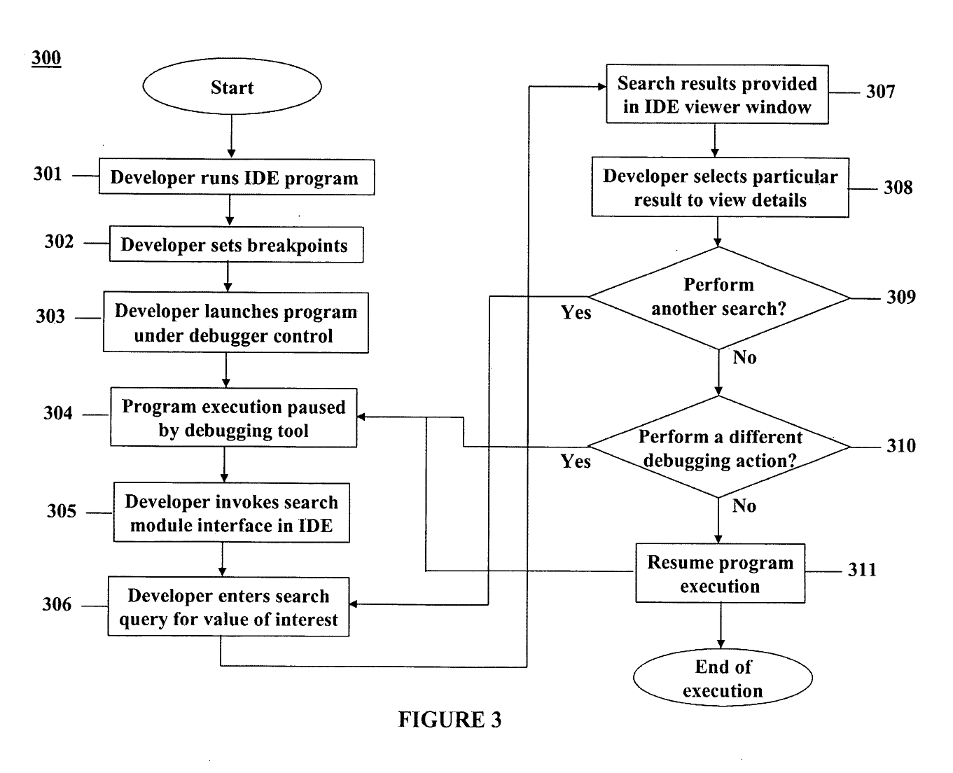

Referring now to FIG. 3, a flow diagram is illustrated showing a sample process of interaction 300 by a developer for performing a search by value in an IDE that includes a debugging tool in which an exemplary embodiment of a search module of the present invention has been implemented. Exemplary process begins at block 301 with the developer opening the IDE to study the behavior of a program. At block 302, the developer uses the debugging tool included in the IDE to set breakpoints for desired stopping points in the source code. At block 303, the developer launches the program under debugger control. At block 304, the running program is stopped or paused by the debugging tool upon encountering a breakpoint, and the debugging tool acquires the accessible data of the paused program to build data structure representations of the accessible data.

In the present exemplary process, with execution of the program stopped or paused, the developer is provided with the option to perform any of the various debugging actions provided by the IDE. At block 305, the developer chooses to perform a search for a particular value of interest and thus invokes the GUI search query component (for example, a widget such as a search query dialog box) provided by the search module implemented within the IDE. At block 306, the developer submits a search query for the value of interest to the search module.

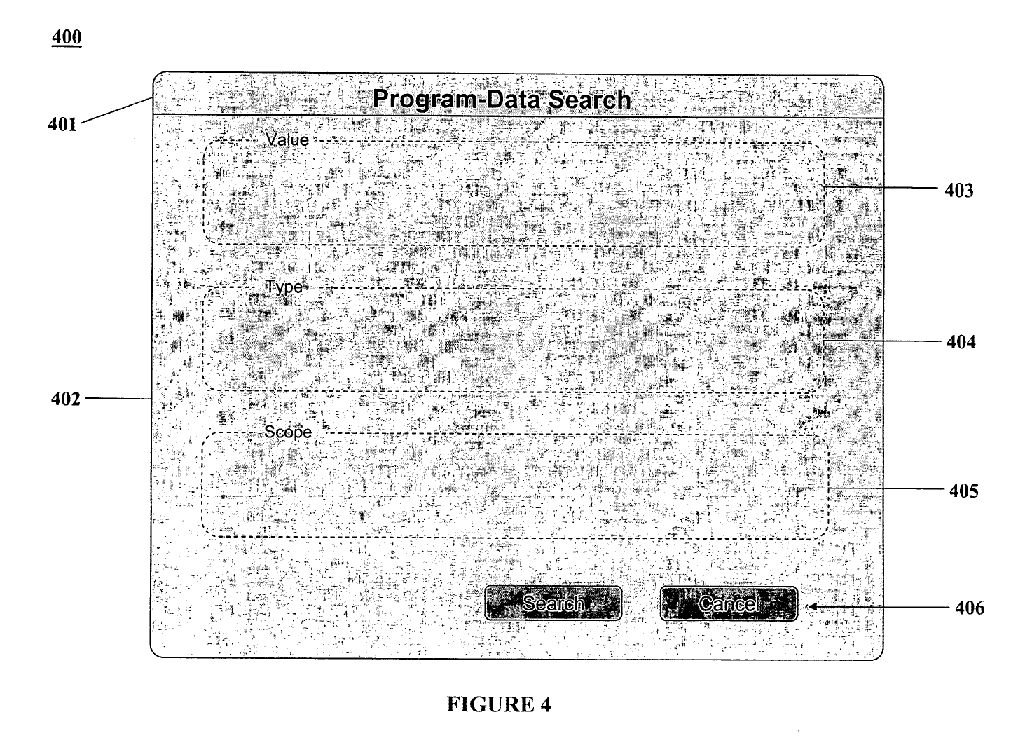

FIG. 4 illustrates an example of such a search query dialog box 400 that can be implemented in exemplary embodiments of the present invention. Example dialog box is provided with the title “Program-Data Search” in a title frame 401. Below title frame 401 is a search frame 402 in which the search parameters can be input by the developer. Search frame 402 includes a first area 403 in which a particular value of interest to be searched can be input by the developer. This first area may be provided in the form of a text box as well as any other suitable GUI widget or interface element. In exemplary embodiments, the search mechanism can be implemented so that the developer can specify further search parameters in addition to the value to search for to filter or narrow the search results as desired. For instance, in the exemplary embodiment of FIG. 4, the developer is provided with the option of limiting the search results by specifying a data type in a second area 404 and/or by specifying a scope for the search in a third area 405. Areas 404 and 405 may each be provided in the form of a text box as well as any other suitable GUI widget or interface element. The data type specified in text box 404 may be, for example, a simple type such as byte, short, char, integer, long, float, double, array, or string (which may optionally be case sensitive), or a complex type. For specifying complex types, the search query dialog box of the search mechanism may provide the developer with the option of browsing through a group of known types and selecting one using, for example, a drop-down list. The scope specified in area 405 may include, for example, the stack, the heap, other globally-accessible data areas, or any combination of these. When including the stack in the scope of the search, the developer may also be provided with the option of restricting the search to the current stack frame or to search through all frames. The developer may also choose to not limit the search by specifying any type or scope information, in which case the system may use various heuristics to match the search value to values assigned to variables of different data types in the program (for example, the value 17 may be matched to both strings and numbers). The lower region of search frame 402 in FIG. 4 contains GUI buttons 406 that are used to submit a search or return control of the IDE to the main debugging window by cancelling the choice to perform a search.

Referring back to exemplary process depicted in FIG. 3, at block 307, the results of the search, computed by the system, are displayed in a search results interface such as a dialog box or a viewer window that contains an entry for each search result (that is, each variable or accessible memory location to which the searched-for value is assigned at the current execution state of the running program). At block 308, when the developer selects a particular search result entry from the results interface, the information presented in the results interface is expanded to display the details for that result. After performing a search and examining the results at blocks 305-308, the developer can be provided with the options of performing a search for another value of interest at block 309, performing additional debugging actions at the current breakpoint as provided for by the IDE at block 310, or choosing to resume running of the program at block 311, in which case the process returns to block 304 if an additional breakpoint is encountered or ends upon program termination.

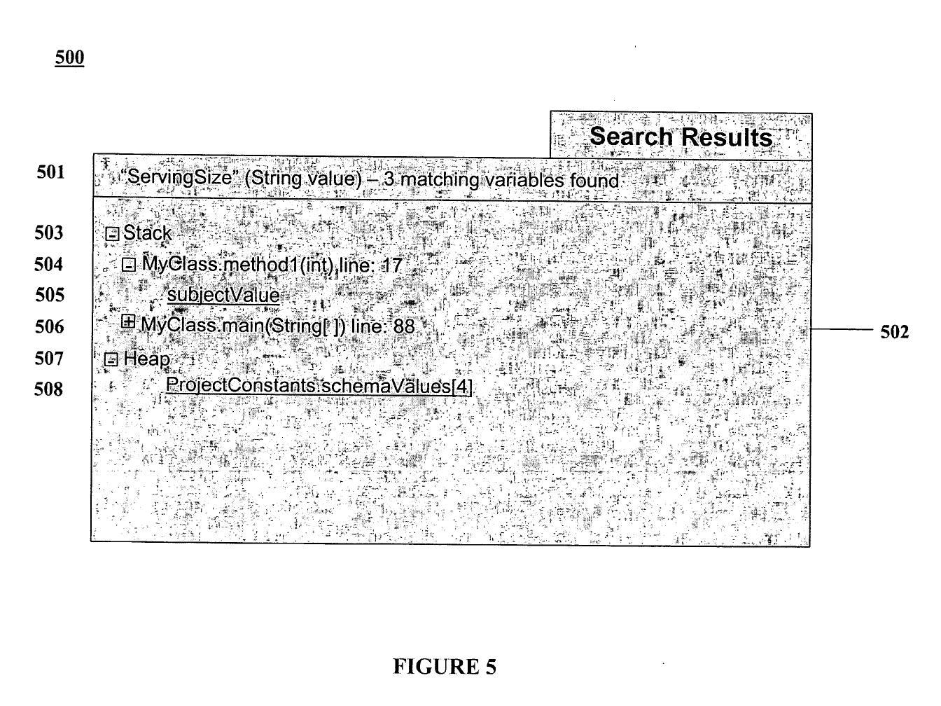

FIG. 5 illustrates a non-limiting example of a search results dialog box 500 that can be implemented in exemplary embodiments of the present invention. Dialog box 500 can be provided, for example, at block 307 in exemplary process 300 described above. Dialog box 500 can be implemented to interoperate with other interfaces, widgets, and editors provided in a GUI debugging environment such as that provided by an IDE. Within exemplary dialog box 500, a heading 501 provides a textual summary of the search results, and a body 502 of the view presents a listing of the search results. In the present example, body 502 displays the search results using an expandable hierarchical view in which a segment for stack results 503 and a segment for heap results 507 are provided in collapsible subtrees. In the sample search results presented in the present example, the searched-for value “ServingSize” was located in two different stack frames 504, 506. The variable details for the value located in the first stack frame are displayed by expanding the first of the hits are shown via tree expansion at 505, as are details of the single located instance of the searched-for value in the heap.

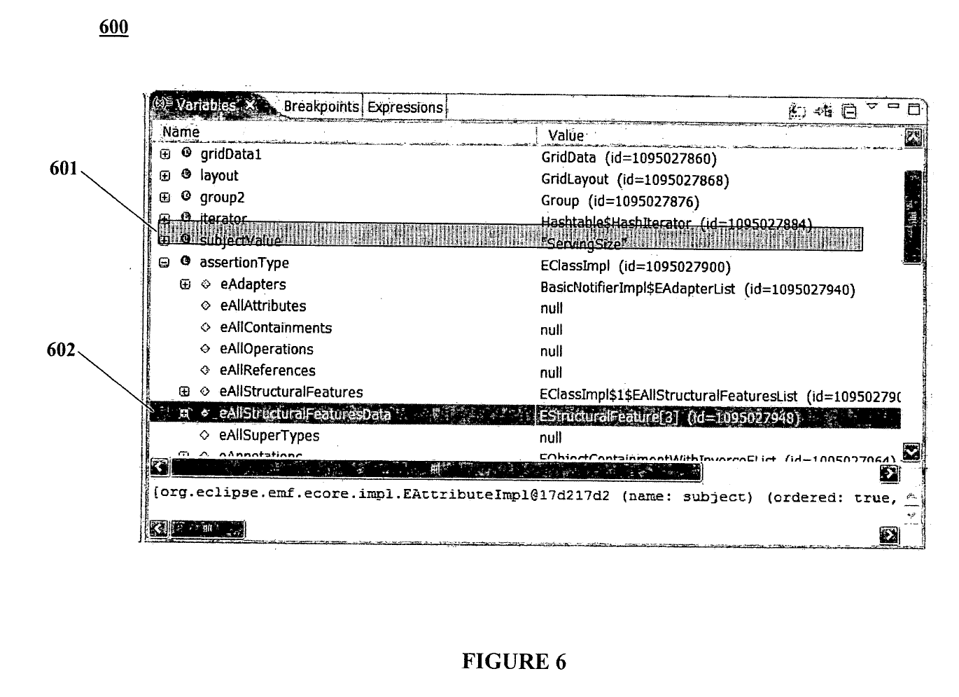

As one alternative to the non-limiting example illustrated in FIG. 5, FIG. 6 illustrates an example of a search results viewer window 600 that can be implemented in exemplary embodiments of the present invention. Viewer window 600 can be provided, for example, at block 307 in exemplary process 300 described above. As can be seen, viewer window 600 is nearly identical to viewer window 100 shown FIG. 1. The notable difference is that viewer window 600 indicates the results of the search to the developer by highlighting the variables to which the searched-for value has been assigned. For example, in the sample search results shown in FIG. 6, the variable ‘subjectValue’ 601 having the searched-for value “ServingSize” is highlighted. Note that, as before, the developer can select and view the details of any other variable (such as selected variable “eAllStructuralFeaturesData” 602), not just those of the search result. In exemplary embodiments, the search mechanism can be implemented to differentiate the highlighted search results from other variables that have been highlighted because they have been selected by the developer.

Exemplary embodiments of the present invention can be configured to be implemented within any software debugging environment. Exemplary embodiments can be implemented as an aspect of a software package for a debugging tool, or as a software module or component implemented for incorporation with a debugging tool as, for example, one or more libraries of functions, one or more plug-in or extension modules, one or more dynamic link-libraries, etc.

Exemplary embodiments of the present invention can be realized in hardware, software, or a combination of hardware and software. Exemplary embodiments can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

Exemplary embodiments of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A computer system in which exemplary embodiments can be implemented may include, inter alia, one or more computers and at least a computer program product on a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

Although exemplary embodiments of the present invention have been described in detail, it should be understood that various changes, substitutions and alternations could be made thereto without departing from spirit and scope of the inventions as defined by the appended claims. Variations described for exemplary embodiments of the present invention can be realized in any combination desirable for each particular application. Thus particular limitations, and/or embodiment enhancements described herein, which may have particular advantages to a particular application, need not be used for all applications. Also, not all limitations need be implemented in methods, systems, and/or apparatuses including one or more concepts described with relation to exemplary embodiments of the present invention.

While exemplary embodiments of the present invention have been described, it will be understood that those skilled in the art, both now and in the future, may make various modifications without departing from the spirit and the scope of the present invention as set forth in the following claims. These following claims should be construed to maintain the proper protection for the present invention.

What is claimed is:

1. A software module for searching within a software debugging environment, the software module comprising:
a search component configured to be implemented within a debugging tool configured to access a set of execution state data for a program being monitored by the debugging tool when execution of the program is stopped, the search component being configured to search the set of execution state data to locate instances of a particular value; and
an interface component configured to allow a user to specify the particular value in a search query, submit the search query to the search component, and present a description of each instance of the particular value located by the search component to the user.

2. The software module of claim 1, wherein the debugging tool is implemented with a user interface of a type selected from command line interface, textual user interface, and graphical user interface, and wherein the interface component is configured to be implemented within the user interface.

3. The software module of claim 1, wherein the debugging tool is configured to allow execution of the program to be stopped at each occurrence of a breakpoint set by the user, a step operation, a program crash, an execution termination point, a trapping exception, and a core dump.

4. The method of claim 1, wherein the interface component is configured to allow the user to optionally specify a particular data type in the search query, and wherein the search component is configured to only locate the instances of the particular value having the data type when the data type is specified by the user.

5. The method of claim 1, wherein the interface component is configured to allow the user to optionally specify particular program scope in the search query, and wherein the search component is configured to only locate the instances of the particular value within the program scope when the program scope is specified by the user.

6. The method of claim 1, wherein the debugging tool is implemented within an integrated development environment having a graphical user interface, wherein the interface component is configured with a search query interface for implementation within the graphical user interface to allow the search query to be specified and submitted, and wherein the interface component is configured with a search results viewing window for implementation within the graphical user interface to present the description of each instance of the particular value located by the search component.
